(19) United States
(12) Patent Application Publication
(10) Pub. No.: US 2011/0114858 A1
(43) Pub. Date: May 19, 2011

(54) Digital input circuit

(75) Inventors: Hiroyuki Oono, Kobe-shi (JP); Takahiro Yoshida, Osaka-shi (JP); Kuniaki Matsuura, Ibaraki-shi (JP)

(73) Assignee: Panasonic Electric Works SUNX Co., Ltd., Aichi (JP)

(21) Appl. No.: 12/926,439

(22) Filed: Nov. 18, 2010

(30) Foreign Application Priority Data
Nov. 18, 2009 (JP) 2009-263191

(51) Int. Cl. G02B 27/00

(52) U.S. Cl. 250/551

(57) ABSTRACT

A digital input circuit includes a pair of input terminals that an input signal of a digital voltage signal is inputted; a photocoupler for transmitting the input signal from the input terminals to an input port of a microcomputer and having one light emitting diode and one phototransistor, wherein the light emitting diode of the photocoupler is connected between the input terminals, a collector of the phototransistor is connected to a positive side of a power supply, and an emitter of the phototransistor is connected to ground via a first resistor; and a bipolar transistor provided between the ground and a second resistor, wherein a collector thereof is connected to the second resistor for pulling up the input port of the microcomputer, an emitter thereof is connected to the ground, and a base thereof is connected to a connection node between the emitter of the phototransistor and the first resistor.

### FIELD OF THE INVENTION

The present invention relates to a digital input circuit for use in, e.g., a programmable logic controller (PLC).

### BACKGROUND OF THE INVENTION

Generally, a PLC is widely used in control of various external apparatuses. Recently, external apparatuses to be controlled tend to have complicated configurations, requiring input/output signals to be processed at a high speed.

There is proposed a general purpose PLC unit 1′ which includes, as shown in FIG. 2, an external connector 15′ to which an external apparatus 11′ to be controlled is connected, a connection connector 16′ to which a CPU unit having a CPU for executing, e.g., a sequence program is connected, a programmable logic device (PLD) 17′ for performing sequence control of the external apparatus 11′ based on the sequence program executed by the CPU, and a display unit 18′ having, e.g., light emitting diodes for displaying an operational state of the PLC unit 1′. The PLC unit 1′ further includes an isolation unit 19′ provided between the external connector 15′ and the PLD 17′ and having plural photocouplers for transmitting input and output signals while electrically isolating the external connector 15′ and the PLD 17′ from each other, a setting switch 20′ for setting an operational state of the PLD 17′, and a power supply unit 21′ for supplying electric power to the PLD 17′, the display unit 18′, isolation unit 19′ and the setting switch 20 (see, e.g., Japanese Patent Application Publication No. 2002-222003). Further, the PLD 17′ is provided with a microcomputer (hereinafter, simply referred to as “micom”) 12′ for detecting an input signal from the external apparatus 11′ or outputting an output signal to the external apparatus 11′.

In the general purpose PLC unit 1′ shown in FIG. 2, a high speed photocoupler having a high response speed compared to a general purpose photocoupler composed of one light emitting diode and one phototransistor may be used as a photocoupler of a digital input circuit of the isolation unit 19′ serving as a digital input/output circuit. In such a case, the PLC unit 1′ can be responsive to the voltage level of the input signal inputted through the external connector 15′ from the external apparatus 11′ rapidly and repeatedly varying between high and low levels. However, the high speed photocoupler is expensive compared to the general purpose photocoupler, making it difficult to realize the digital input circuit at a low cost.

Accordingly, there is proposed a digital input circuit 2′ using a general purpose photocoupler which includes, e.g., a pair of input terminals T3′ and T4′ through which an input signal is inputted from, e.g., the external apparatus 11′, and a general purpose photocoupler PC5′ for transmitting the input signal from the input terminals T3′ and T4′ to, e.g., the micom 12′, as shown in FIG. 3, (see, e.g., Japanese Utility Model Application Publication No. S63-147702).

The photocoupler PC5′ is formed of a package that includes a light emitting diode LD6′ and a phototransistor PT8′ facing the light emitting diode LD6′ and being switched on and off according to on and off of the light emitting diode LD6′.

In the digital input circuit 2′ described above, the light emitting diode LD6′ of the photocoupler PC5′ is connected between the input terminals T3′ and T4′ via a resistor R9′ for restricting electric current. A resistor R10′ is connected in parallel to the light emitting diode LD6′. Further, the collector terminal of the phototransistor PT8′ of the photocoupler PC5′ is connected to the positive side of a power supply Vcc, and the emitter terminal of the phototransistor PT8′ is connected to an input port of the micom 12′ via a resistor R23′ and a buffer circuit BU26′. Further, the connection node between the emitter terminal of the phototransistor PT8′ and the resistor R23′ is connected to the ground via a resistor R24′. The connection node between the resistor R23′ and the buffer circuit BU26′ is connected to the ground via a capacitor C25′.

Hereinafter, an operation of the digital input circuit 2′ shown in FIG. 3 will be described.

For example, if the voltage level of the input signal inputted from the external apparatus 11′ is changed from low to high, a diode turn-on voltage is applied between the input terminals T3′ and T4′. Accordingly, the light emitting diode LD6′ is turned on and an electric current I11′ flows in the light emitting diode LD6′ of the photocoupler PC5′. Resultantly, the phototransistor PT8 is switched on (i.e., becomes in an ON state). Then, the voltage level of the input port of the micom 12′ is changed from low to high.

On the other hand, if the voltage level of the input signal is changed from high to low, a diode turn-on voltage is not applied between the input terminals T3′ and T4′. Accordingly, the light emitting diode LD6′ is turned off and the electric current I11′ does not flow in the light emitting diode LD6′ of the photocoupler PC5′. As a result, the phototransistor PT8′ is switched off (i.e., becomes in an OFF state). Then, the voltage level of the input port of the micom 12′ is changed from high to low.

Accordingly, in a PLC including such micom having the input port connected to an output terminal of the buffer circuit BU26′ of the digital input circuit 2′ having a circuit configuration shown in FIG. 3, the voltage level (high level or low level) of the input signal from an external apparatus can be detected by the micom.

In the digital input circuit 2′ having the circuit configuration shown in FIG. 3, the emitter terminal of the phototransistor PT8′ is connected to the ground via the resistor R24′. Thus, when the phototransistor PT8′ is in the ON state, the collector-emitter voltage of the phototransistor PT8′ becomes approximately 0 V, and the phototransistor PT8′ is in a saturated state. Accordingly, when the state of the phototransistor PT8′ is switched from an ON state to an OFF state, response delay occurs due to the mirror effect of the phototransistor PT8′ and long accumulation time of the base-emitter capacitance of the phototransistor PT8′ (base storage time). Thus, if the voltage level of the input signal (of high speed pulse) repeatedly varies at a high speed in the digital input circuit 2′ having the circuit configuration shown in FIG. 3, it is difficult that all input signals are identified in the micom 12′.

Therefore, in order to make a response to an input signal of high speed pulse, it is preferable to use a photocoupler having high response speed rather than a general purpose photocoupler. However, it is difficult to realize the circuit at a low cost with the photocoupler having high response speed.

### SUMMARY OF THE INVENTION

In view of the above, the present invention provides a digital input circuit capable of achieving a high response speed at a low cost.

In accordance with an embodiment of the present invention, there is provided a digital input circuit including: a pair of input terminals through which an input signal of a digital voltage signal is inputted; a power supply; a photocoupler serving as a signal transmitting element for transmitting the input signal from the input terminals to an input port of a microcomputer and having one light emitting diode and one phototransistor, wherein the light emitting diode of the photocoupler is connected between the input terminals, a collector of the phototransistor is connected to a positive side of the power supply, and an emitter of the phototransistor is connected to ground via a first resistor; a second resistor for pulling up the input port of the microcomputer; and a bipolar transistor provided between the ground and the second resistor, wherein a collector of the bipolar transistor is connected to the second resistor, an emitter of the bipolar transistor is connected to the ground, and a base of the bipolar transistor is connected to a connection node between the emitter of the phototransistor and the first resistor.

In this configuration, the emitter of the phototransistor is connected to the ground via the first resistor. The bipolar transistor is provided between the ground and the second resistor for pulling up the input port of the microcomputer. In the transistor, the collector is connected to the second resistor, the emitter is connected to the ground. The base of the transistor is connected to the connection node between the first resistor and the emitter of the phototransistor. Accordingly, when the phototransistor is switched on, the potential at the connection node becomes equal to the base-emitter voltage of the bipolar transistor. Thus, the collector-emitter voltage of the phototransistor does not become 0 V. Therefore, the input signal can be identified at the input port of the microcomputer in a state where the bipolar transistor is switched on and off while maintaining the phototransistor in an unsaturated state.

Further, since the collector-emitter voltage swing of the phototransistor is small, a mirror effect of the phototransistor hardly occurs. Further, a switching operation can be performed while the phototransistor is not in a saturated state and the collector-emitter voltage of the phototransistor varies within a small range. Accordingly, response delay, which occurs due to the mirror effect and the long accumulation time of the base-emitter capacitance of the phototransistor, can be shortened when the state of the phototransistor is changed from an ON state to an OFF state.

Further, even though a photocoupler having high response speed is not used as a signal transmitting element, it is possible to identify an input signal of high speed pulse at the input port of the microcomputer with the above-described photocoupler including one light emitting diode and one phototransistor. Therefore, it is possible to achieve a high response speed at a low cost by using inexpensive general purpose circuit elements such as the bipolar transistor and the second resistor (pull-up resistor) in addition to the above-described photocoupler including one light emitting diode and one phototransistor.

In accordance with the embodiment of the present invention, a digital input circuit achieving a high response speed at a low cost can be provided.

### BRIEF DESCRIPTION OF THE DRAWINGS

The objects and features of the present invention will become apparent from the following description of embodiments given in conjunction with the accompanying drawings, in which:

FIG. 1 illustrates a circuit diagram showing a digital input circuit in accordance with an embodiment of the present invention;

FIG. 2 illustrates a block diagram of a conventional general purpose PLC unit; and

FIG. 3 illustrates a circuit diagram showing a conventional digital input circuit.

### DETAILED DESCRIPTION OF THE EMBODIMENT

An embodiment of the present invention will be described with reference to the accompanying drawings which form a part hereof.

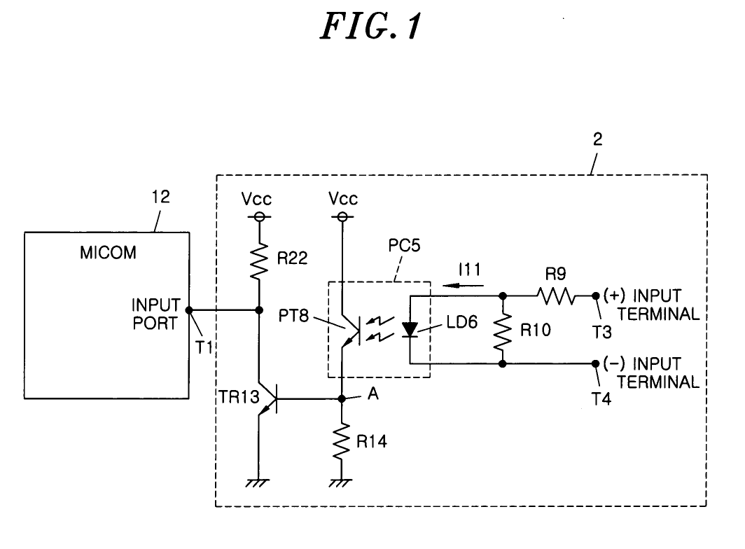

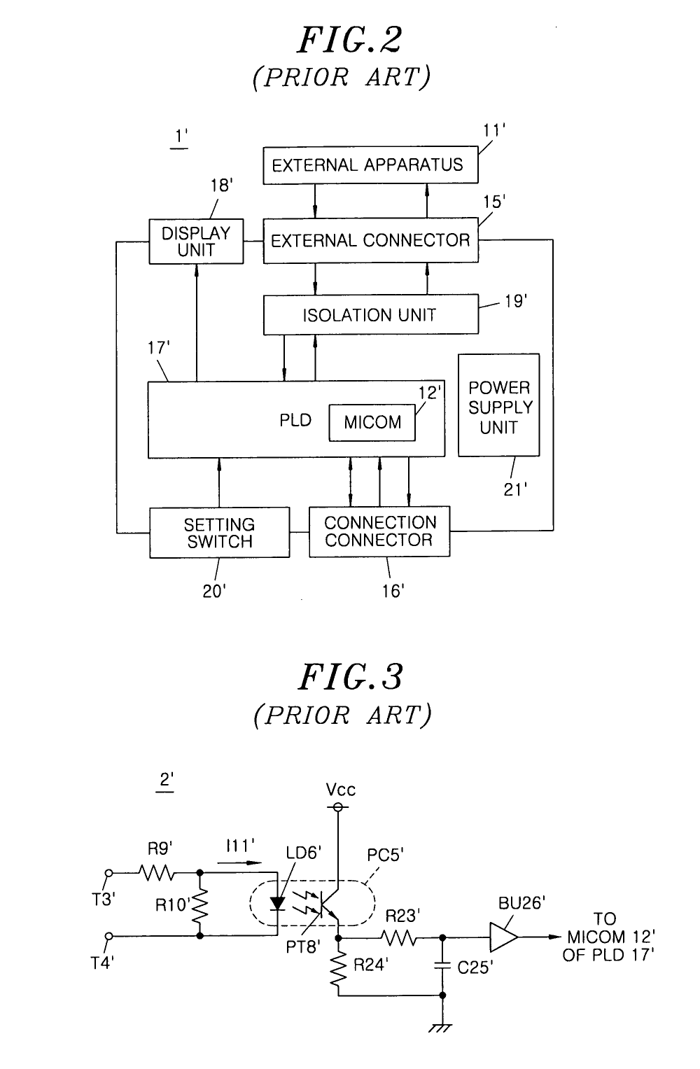

A digital input circuit 2 in accordance with the embodiment of the present invention may be used in, e.g., the isolation unit 19′ of the programmable logic controller (PLC) unit 1′ shown in FIG. 2, and includes a general purpose photocoupler serving as a signal transmitting element and having one light emitting diode and one phototransistor. Specifically, the digital input circuit 2 includes, as shown in FIG. 1, a pair of input terminals T3 and T4 through which a digital voltage input signal is inputted from, e.g., the external apparatus 11′ shown in FIG. 2; a general purpose photocoupler PC5 serving as a signal transmitting element for transmitting the input signal from the input terminals T3 and T4 to a microcomputer (hereinafter, simply referred to as “micom”) 12 and having one light emitting diode LD6 and one phototransistor PT8; and a general purpose bipolar transistor TR13 that allows the micom 12 to detect a voltage level of the input signal from the external apparatus by a switching operation of the phototransistor PT8.

The micom 12 includes an input port T1 for the detection of voltage level (high level or low level) of the input signal from the external apparatus. In the PLC, the input signal from the external apparatus is identified in the micom 12 and the micom 12 executes a sequence program stored in a memory.

The photocoupler PC5 includes the light emitting diode LD6 serving as a light emitting element and the phototransistor PT8 serving as a light receiving element facing the light emitting diode LD6, which are arranged in one package (e.g., a resin package or the like). The input signal is transmitted while the light emitting diode LD6 and the phototransistor PT8 are electrically isolated from each other.

In the digital input circuit 2, the light emitting diode LD6 is connected between the input terminals T3 and T4 via a resistor R9 for restricting electric current. A resistor R10 is connected in parallel to the light emitting diode LD6. The collector terminal of the phototransistor PT8 of the photocoupler PC5 is connected to the positive side of a power supply Vcc, and the emitter terminal of the phototransistor PT8 is connected to the ground via a resistor R14. Further, an npn type transistor TR13 is provided between the ground and a pull-up resistor R22 for pulling up the input port T1 of the micom 12. The collector terminal of the transistor TR13 is connected (pulled up) to the positive side of the power supply Vcc via the pull-up resistor R22, and the emitter terminal of the transistor TR13 is directly connected to the ground. Further, the base terminal of the transistor TR13 is connected to the connection node A between the emitter terminal of the phototransistor PT8 and the resistor R14. The connection node between the collector terminal of the transistor TR13 and the pull-up resistor R22 is connected to the input port T1 of the micom 12.

In this case, when Vcc power is supplied to the digital input circuit 2 while no input signal is applied to the digital input circuit 2, a voltage level of the input port T1 becomes a high level (voltage level of the power supply Vcc). The voltage level of the input signal from the external apparatus is detected by the micom 12 having such an input port T1.

Hereinafter, an operation of the digital input circuit 2 in accordance with the embodiment of the present invention will be described.

For example, if the voltage level of the input signal inputted from the external apparatus is changed from low to high, a diode turn-on voltage is applied between the input terminals T3 and T4. Accordingly, the light emitting diode LD6 is turned on and an electric current I11 flows in the light emitting diode LD6 of the photocoupler PC5. Resultantly, the phototransistor PT8 becomes in an ON state. The base/emitter of the transistor TR13 is biased at a potential of the connection node A between the resistor R14 and the emitter terminal of the phototransistor PT8 and the transistor TR13 is turned on. Thus, the voltage level of the input port T1 of the micom 12 is changed from high (voltage level of the power supply Vcc) to low.

Accordingly, when the phototransistor PT8 is in an ON state, the potential at the connection node A between the resistor R14 and the emitter terminal of the phototransistor PT8 becomes equal to the base-emitter voltage of the transistor TR13. Thus, the collector current flows in the phototransistor PT8 while the collector-emitter voltage of the phototransistor PT8 does not become 0 V. Therefore, the voltage level of the input signal can be identified at the input port T1 of the micom 12 in a state where the transistor TR13 is switched on and off while maintaining the phototransistor PT8 in an unsaturated state.

If the voltage level of the input signal inputted from the external apparatus is changed from high to low, a diode turn-on voltage is applied between the input terminals T3 and T4. Accordingly, the light emitting diode LD6 is turned off and the electric current I11 does not flow in the light emitting diode LD6 of the photocoupler PC5. Thus, the phototransistor PT8 becomes in an OFF state. If the phototransistor PT8 becomes in an OFF state, the collector current does not flow in the phototransistor PT8, and thus the base/emitter of transistor TR13 is not forward-biased. Accordingly, the transistor TR13 also becomes in an OFF state, and the voltage level of the input port T1 of the micom 12 is changed from low to high (voltage level of the power supply Vcc).

Accordingly, in the PLC including the micom 12 having the input port T1 connected to the connection node between the pull-up resistor R22 and the collector terminal of the transistor TR13 of the digital input circuit 2 having the circuit configuration shown in FIG. 1, the change in the voltage level (high level or low level) of the input signal from the external apparatus can be detected by the micom 12.

In the digital input circuit 2 described above, the emitter terminal of the phototransistor PT8 is connected to the ground via the resistor R14. The bipolar transistor TR13 is provided between the ground and the pull-up resistor R22 pulling up the input port T1 of the micom 12. In the transistor TR13, the collector terminal is connected to the pull-up resistor R22 and the emitter terminal is connected to the ground. The base terminal of the transistor TR13 is connected to the connection node A between the emitter terminal of the phototransistor PT8 and the resistor R14. Accordingly, when the phototransistor PT8 is switched on, the potential at the connection node A becomes equal to the base-emitter voltage of the bipolar transistor TR13. Thus, the collector-emitter voltage of the phototransistor PT8 does not become 0 V. Therefore, the input signal can be identified at the input port T1 of the micom 12 in a state where the bipolar transistor TR13 is switched on and off while maintaining the phototransistor PT8 in the unsaturated state. Further, since the collector-emitter voltage swing of the phototransistor PT8 is small, a mirror effect of the phototransistor PT8 hardly occurs.

In the digital input circuit 2 in accordance with the embodiment of the present invention, a switching operation can be performed while the phototransistor PT8 is not in the saturated state and the collector-emitter voltage of the phototransistor PT8 varies within a small range. Accordingly, response delay, which occurs due to the mirror effect and the base storage time of the phototransistor PT8, can be shortened when the state of the phototransistor PT8 is changed from an ON state to an OFF state. Further, even though a photocoupler having high response speed is not used as a signal transmitting element, it is possible to identify an input signal of high speed pulse at the input port T1 of the micom 12 with the general purpose photocoupler PC5 including one light emitting diode LD6 and one phototransistor PT8. Therefore, it is possible to achieve a high response speed at a low cost by using inexpensive general purpose circuit elements such as the transistor TR13 and the pull-up resistor R22 in addition to the general purpose photocoupler PC5.

While the invention has been shown and described with respect to the embodiments, it will be understood by those skilled in the art that various changes and modification may be made without departing from the scope of the invention as defined in the following claims.

What is claimed is:

1. A digital input circuit comprising:
a pair of input terminals through which an input signal of a digital voltage signal is inputted;
a power supply;
a photocoupler serving as a signal transmitting element for transmitting the input signal from the input terminals to an input port of a microcomputer and having one light emitting diode and one phototransistor, wherein the light emitting diode of the photocoupler is connected between the input terminals, a collector of the phototransistor is connected to a positive side of the power supply, and an emitter of the phototransistor is connected to ground via a first resistor;
a second resistor for pulling up the input port of the microcomputer; and
a bipolar transistor provided between the ground and the second resistor, wherein a collector of the bipolar transistor is connected to the second resistor, an emitter of the bipolar transistor is connected to the ground, and a base of the bipolar transistor is connected to a connection node between the emitter of the phototransistor and the first resistor.
